(19) United States
(12) Patent Application Publication
(10) Pub. No.: US 2026/0260777 A1
(43) Pub. Date: Sep. 3, 2026

(54) Flexible glass element and method for its production

(71) Applicant: SCHOTT AG, Mainz (DE)

(72) Inventors: Lars Müller, Mainz (DE); Fabian Wagner, Mainz (DE); Andreas Ortner, Mainz (DE); Rule Kirchhoff, Mainz (DE)

(21) Appl. No.: 18/863,684

(22) PCT Filed: Apr. 26, 2023
(86) PCT No.: PCT/EP2023/060959

§ 371 Date: Nov. 7, 2024

(30) Foreign Application Priority Data
May 17, 2022 (DE) 102022112386.3

(51) Int. Cl. H01B 3/08; H01B 17/30; H01B 19/04

(52) U.S. Cl. CPC H01B 3/088; H01B 17/305; H01B 19/04

(57) ABSTRACT

A glass element (1) with a second portion (5) which can be deflected with respect to a first portion (3), wherein the first portion (3) and the second portion (5) are connected to one another by way of a connecting portion (7), wherein the first portion (3), the second portion (5) and the connecting portion are formed in one piece and wherein the connecting portion (7) is designed to be flexibly deformable in such a way that the connecting portion is bendable, and extendable or compressible, and so the second portion (5) is movable with respect to the first portion (3) by the connecting portion (7) being deformed.

In general terms, the invention relates to the structuring of glass. In particular the invention relates to structuring of glass in such a way that increased flexibility is imparted locally to the glass.

### BACKGROUND

The structuring of glass in order to introduce openings or recesses of any desired shape is known from the prior art, e.g. from DE 10 2018 100 299 A1 and DE 10 2018 110 211 A1.

### SUMMARY OF THE INVENTION

EP 3 936 485 A1 describes a flexible element consisting of an inorganic brittle material and the production thereof. The element has at least three portions, wherein a first portion is arranged between two second portions. The first portion comprises an arrangement of openings, which form passages from one side to the opposite side of the element, with the result that the first portion has a higher flexibility than the second portion. The first portion thus acts as a hinge between the two second portions. In some cases, however, it may be undesirable or disadvantageous for a glass element to have through openings. This may be the case, for instance, if the glass element is supposed to be gastight and/or to provide a shield against dirt or moisture. Moreover, the arrangement of the openings is designed, in particular, in such a way that bending is made possible. However, it may furthermore also be desirable to enable simple stretching or compression of the flexible portion. This is the case, inter alia, when mechanical damping of an internal portion of the glass element with respect to surrounding portions separated from the inner portion by the flexible portion is to be provided. It is precisely with glass as a hard and brittle material that there is the inherent problem of abrupt mechanical shocks potentially leading to damage. This problem occurs, inter alia, with electrical leadthroughs, where shock loading, for example, on the leadthrough conductor may lead to a crack and thus to a leak in the leadthrough. In this regard, WO 2021/061481 A1 discloses a leadthrough in which the glass insulation has a trough that surrounds the leadthrough conductor. This trough is intended to prevent a crack due to a mechanical action from propagating further. The disadvantage here is that, although crack propagation and thus damage is limited, it is nevertheless present. In view of this, it would be desirable to entirely avoid damage in order to make a leadthrough more resistant to repeated mechanical actions.

It is an object of the invention to make available a glass element which has the abovementioned additional properties. It is also an object of the invention to impart local flexibility to a workpiece that is originally not flexible or has only minimal flexibility by means of structuring, with a certain area being made deflectable with respect to the remainder of the element by means of surrounding structuring. The structuring should be so pronounced that the deflection is made possible, in particular, perpendicularly to the workpiece surface, or at least has a perpendicular component.

For this purpose, a glass element with a second portion, which can be deflected with respect to a first portion, is provided, wherein the first portion and the second portion are connected to one another by way of a connecting portion, wherein the first portion, the second portion and the connecting portion are formed in one piece and wherein the connecting portion is designed to be flexibly deformable in such a way that the connecting portion is bendable, and stretchable or compressible, thus enabling the second portion to be moved with respect to the first portion, with the connecting portion being deformed.

In particular, the structuring of the connecting portion can be such that the structuring does not open the volumes hermetically sealed from one another by the workpiece to one another, and therefore the structuring remains gastight. Accordingly, the connecting portion in a preferred embodiment of the invention can form a gastight connection between the first portion and the second portion.

According to a preferred embodiment, the glass element is of plate-shaped design, wherein the first portion surrounds the second portion. In this case, the second portion can, for example, form a button which can be actuated, in particular pressed in, relative to the surrounding glass sheet or surrounding first portion.

In order to facilitate the deformability of the connecting portion, it is furthermore preferred if the connecting portion has a thickness which, at least in some region or regions, is reduced relative to the first and/or the second portion.

The deformability, in particular also the stretching or compression, can be achieved in a particularly effective manner if the connecting portion has at least one surface offset, such that the connecting portion has at least two regions, the surfaces of which are at different levels in a direction perpendicular to the surface of the first or the second portion. This shaping enables stretching or compression to be converted into bending of the material between these two regions. The bending enables the two regions to move away from one another or toward one another. In particular, the connecting portion can have at least one loop or meander. This gives the connecting portion a cross-sectional shape similar to a bellows, such as, in particular, a corrugated or convoluted bellows.

The invention is explained in greater detail below with reference to the attached figures. In the figures, identical reference signs in each case refer to identical or corresponding elements.

### BRIEF DESCRIPTION OF THE FIGURES

FIG. 1 shows a plan view of a plate-shaped glass element.

FIG. 2 is a cross-sectional view of the plate-shaped glass element.

FIG. 3 shows a tubular glass element.

FIG. 4 shows a plate-shaped glass element in cross section.

FIG. 5 shows a variant of the example in FIG. 4.

FIG. 6 shows four examples of glass elements with connecting portions of different shapes.

FIG. 7 shows a diagram with occurring stresses on the connecting element and deflections of one portion of the glass element under various force effects.

FIG. 8 shows a glass element with a second portion deflected under the effect of a force.

FIG. 9 shows a diagram with the stresses and forces which occur with a specified deflection for various embodiments of glass elements.

FIG. 10 to FIG. 12 show method steps for the production of a glass element.

FIG. 13 shows a variant of the glass element with oblique offset strips.

FIG. 14 shows a pushbutton with a glass element.

FIG. 15 shows a variant of the pushbutton.

FIG. 16 shows an operating cover of a smartphone or tablet PC.

FIG. 17 shows a sensor with a glass element.

FIG. 18 shows an electrical leadthrough.

### DETAILED DESCRIPTION OF THE FIGURES

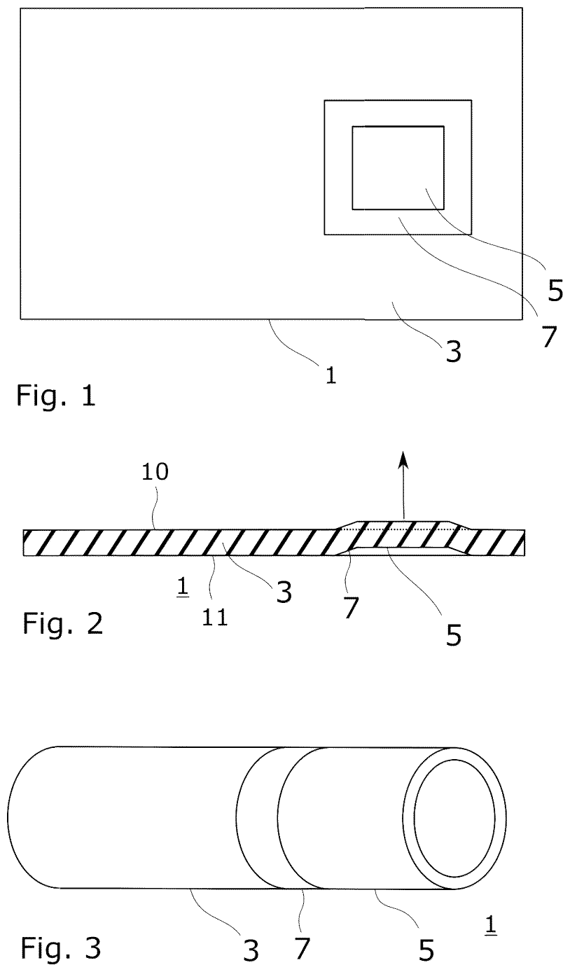

FIG. 1 shows a schematic plan view of a glass element 1. According to one embodiment, which also forms the basis for the example shown in FIG. 1, the glass element 1 is of plate- or disk-shaped design. The glass element 1 is subdivided into a first portion 3, a second portion 5 and a connecting portion 7 connecting the two portions 3, 5. Said three portions 3, 5, 7 are formed integrally or monolithically. This means, in particular, that the three portions 3, 5, 7 are formed from the same glass. In general, without limitation to the example illustrated, it is preferred that the first region 3 surrounds the second region 5 in the case of a plate- or disk-shaped glass element 1, and therefore the second portion 5 is preferably completely surrounded by the first portion 3. Here, therefore, the connecting portion 7 has the form of a closed or encircling ring which encloses and annularly surrounds the second portion 5. In the purely schematic example illustrated, the connecting portion 7 has sharp corners. In practice, in contrast to what is illustrated, it may be advantageous in general, for the sake of making deformation easier, if the connecting portion 7 has corners that are rounded.

The connecting portion 7 is of flexible design and, in particular, can be stretched or compressed. In the example illustrated, it is the stretchability that is of importance, in particular. By virtue of the fact that the connecting portion 7 can be stretched, it is possible to deflect the second region 5 with respect to the first region 3 in a direction perpendicular to the surface. In general terms, without limitation to particular exemplary embodiments, provision is therefore made, as a development of the invention, for the connecting portion 7 to enable a movement of the second portion 5 with respect to the first portion 3 in a direction that has a component perpendicular to the surface of the second portion 5. In particular, this movement can also be precisely perpendicular to the surface or along the surface normal of the second portion 5. In certain circumstances, there may also be a desire for movements which are substantially perpendicular. In the sense of this disclosure, this is understood to mean a movement, the motion component of which perpendicular to the surface of the second portion 5 is greater in terms of absolute value than the absolute value of the motion component along, i.e. parallel to, the surface of the second portion 5.

This is illustrated more precisely by the schematic cross-sectional view of a plate-shaped glass element 1 in FIG. 2. The glass element 1 has two opposite sides 10, 11. The second portion 5 can be deflected in a direction perpendicular to the sides 10, 11 by the effect of a force, e.g. by pressure by means of a finger. In FIG. 2, the second portion 5 is illustrated in a deflected position, with the direction of the deflection being symbolized by an arrow. As can be seen from FIG. 2, the deflection of the second portion 5 on the one hand requires bending and on the other hand also stretching of the connecting portion 7.

Another embodiment is shown in FIG. 3. In this embodiment, the glass element 1 is designed as a tube. Here, the portions 3, 5, 7 are longitudinal portions of the tube, wherein the two portions 3, 5 are connected to one another by the connecting portion 7. By virtue of the fact that the connecting portion 7 is not only bendable but also stretchable and compressible, this arrangement enables the two portions 3, 5 to be angled relative to one another.

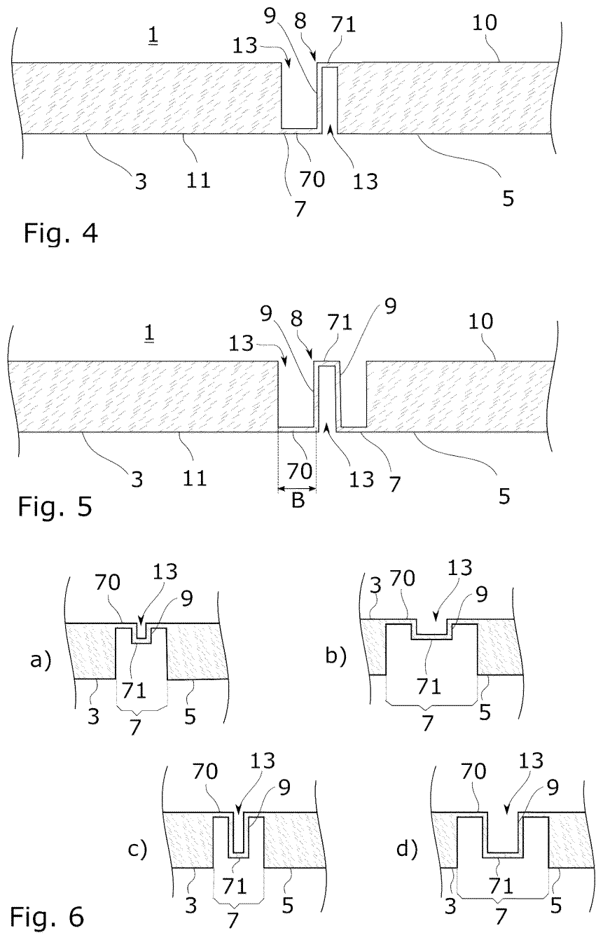

The way in which the connecting portion 7, which is shown only schematically in FIGS. 1 to 3, is shaped in order to enable such deformation is explained in more detail below with reference to various embodiments. In this regard, FIG. 4 shows a detail of a glass element 1 in cross section. The glass element 1 has a first portion 3 and a second portion 5, which are connected to one another via a connecting portion 7, wherein the connecting portion 7 has a certain flexibility, which allows stretching or compression as well as bending, thus enabling the two portions 3, 5 to be tilted relative to one another and also to be offset transversely to the sides 10, 11 of said portions.

To enable this flexibility, the connecting portion 7, as also in the example illustrated, has a reduced thickness relative to the first or the second portion 3, 5, at least in some region or regions. This alone is sufficient to allow easier bending of the glass element 1 on the connecting portion 7. The glass element 1 is preferably structured in such a way that the reduced thickness relative to the first or the second portion 3, 5, at least in some region or regions, has a value in the range of 10 μm to 200 μm, preferably in the range of 20 μm to 100 μm.

In order to allow stretchability or compressibility of the connecting portion 7, a preferred embodiment makes provision, in general terms and without limitation to the example shown, for the connecting portion 7 to have at least one step or surface offset 8, such that the connecting portion 7 has at least two strips 70, 71 (see, e.g., FIG. 4), the surfaces of which are at different levels in a direction perpendicular to the surface of the first or the second portion 3, 5. These offset strips 70, 71 can be connected to one another, in particular, by another strip of the connecting portion 7. Such a strip is referred to below as an offset web. As also in the exemplary embodiment shown in FIG. 4, the offset web 9 is preferably tilted in its orientation by 90° relative to the orientation of the sides of the portions 3, 5. Thus, if the sides 10, 11 of the portions 3, 5 are horizontal, the offset web 9 is oriented perpendicularly. The tilting does not have to amount to precisely 90°: in general, the offset web 9 can be oriented in such a way with respect to one of the sides 10, 11 of one of the portions 3, 5 that there is an angle in the range of 60° to 120°, preferably 80° to 100°, between the side 10, 11 and the surface of the offset web 9.

In general, the stretchability and compressibility of the connecting portion 7 is brought about by the connecting portion 7 having regions with mutually sloping surfaces, or surfaces with a varying surface normal. This makes it a simple matter to convert stretching or compression into a slight change in the angle between the surfaces. As can be seen from FIG. 4, the surface of the connecting portion 7 is shaped in such a way that at least one groove or channel 13 is formed. This feature is not limited to the specific example. The connecting portion 7 can then be stretched or compressed in a direction perpendicular to the longitudinal direction of the channel 13. As a particular preference, a plurality of channels 13 is formed, such that adjacent channels are open toward different sides 10, 11 of the glass element 1. If the connecting portion 7 runs in a ring shape, this also applies to the one or more channels 13. Without limitation to the example illustrated, a development of this embodiment envisages that the connecting portion has at least 3 or more, according to yet another development at least 5, channels 13. For a given width of the channels, the total width of the connecting portion also increases with the number of channels. It is therefore advantageous, on the other hand, if the connecting portion 7 has at most 200, preferably at most 100, channels. However, the number of channels 13 is preferably limited to at most 50, in particular to at most 20, in order to reduce the production effort. In general and preferably typically, the channels 13 run concentrically.

In the example in FIG. 4, there is only a single offset web 9, which forms the side wall of two adjacent channels 13. Higher stretchability or compressibility is achieved if there is a plurality of such offset webs 9. In this regard, FIG. 5 shows an example of a general embodiment in which the connecting portion 7 has a channel 13 that is at a distance from the transitions from the connecting portion 7 to the adjoining first and second portions 3, 5. As illustrated, this channel 13 can be delimited by two such offset webs 9. The shape of the connecting portion 7 can also be described in terms of the connecting portion 7 having at least one loop or meander. The channel 13 or sequence of channels 13 open to opposite sides 10, 11 of the glass element 1 forms a part of this loop or meander.

As is apparent from the embodiments in FIG. 5 and FIG. 6, the connecting portion 7 is designed as a continuous connection without openings. In general, without limitation to the specific examples, provision is therefore made, in a particularly preferred embodiment, for the connecting portion 7 to form a fluidtight, in particular also gastight, connection between the first portion 3 and the second portion 5. This is a simple way of enabling the use of the glass element 1 for applications in which the glass element 1 is also intended to form a barrier with respect to the action of gases or liquids. This is advantageous, for example, for use as a cover for displays. The glass element 1 according to this disclosure thus makes it possible also to design flexible, in particular hinged or foldable, displays.

A channel 13 of the kind shown in FIG. 5 can now be modified in various ways in terms of its shape. FIG. 6 shows four different embodiments of a channel 13 of the connecting portion 7. In example a), the central channel 13 is of narrow and shallow design. In example b), the channel 13 is likewise shallow but also wide. In example c), a narrow but deep channel 13 is provided. Finally, example d) has a channel that is both wide and deep. The description which follows examines how the various channel shapes affect the deformability of the connecting portion 7. For this purpose, glass elements 1 with a thickness of 1 mm were used. Here, the glass thickness in the connecting portion 7 is reduced by a factor of 20 to 0.05 mm. Unlike what is illustrated in the figures, the transitions between the strips 70, 71 and the offset webs 9 are slightly rounded, with edge radii of 0.025 mm at all edges. In the case of wide strips 70, 71 and wide offset webs, the width thereof was 0.9 mm in each case. In the case of short strips 70, 71 and offset webs 9, as in example a) of FIG. 6, for instance, the width was one quarter of this value, that is to say about 0.225 mm. It is apparent that the illustration in FIG. 6 is not to scale in this respect since the narrow strips and webs of the calculated examples are significantly narrower in relation to the wide strips and webs than is shown in the schematic illustration.

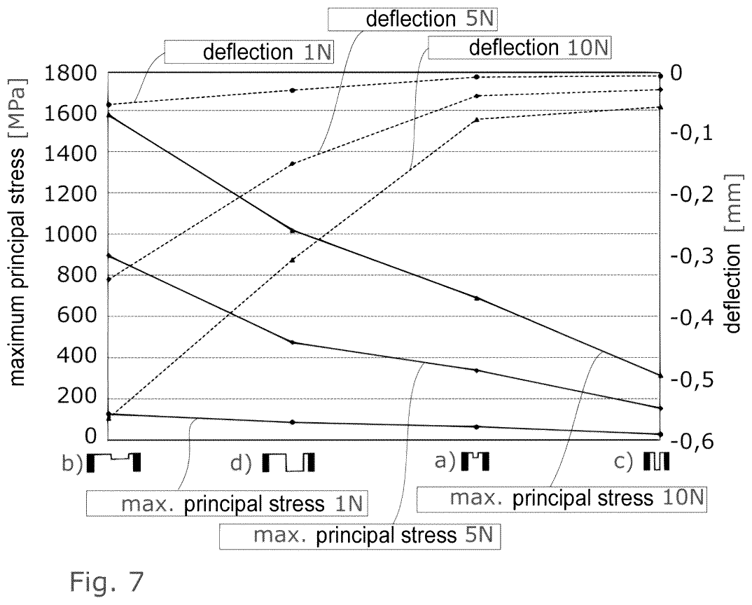

FIG. 7 shows a diagram with occurring stresses on variously shaped connecting elements and the deflections that arise under various force effects. The connecting portions 7 are shown schematically below the diagram and denoted by letters a)-d). These letters indicate the embodiments shown in FIG. 6. The calculation applies to the deflection of the second portion 5 with respect to the first portion 3 under the effect of a force perpendicular to one of the sides 10 or 11 and the resulting deflection perpendicular to the side 10 or 11. In FIG. 7, the four embodiments are ordered in a rising sequence from left to right as regards the maximum stress that occurs during deflection. Moreover, the maximum stress occurs at an inner edge under tensile stress. As can be seen from the diagram, the various embodiments behave very differently as regards the maximum stress and deflection. Here, the embodiments with narrow channels (embodiments a) and c)) are distinguished by smaller deflections with, at the same time, also lower maximum principal stresses. In contrast, the embodiments with wide channels 13 exhibit comparatively large deflections and also high maximum stresses for a given force. As explained, the maximum tensile stresses which occur are dependent on the shape and dimensions of the connecting portion. In general terms, the connecting portion 7 can be designed in such a way that a maximum stress which is less than 400 MPa, preferably less than 200 MPa, in particular less than 100 MPa, and very particularly preferably less than 80 MPa, occurs in the connecting portion 7 when subject to a load. This maximum stress refers, in particular, to the maximum deflection entailed by the respective application. In the case of a switch, for example, there may be a stop which limits the deflection. The abovementioned maximum stresses then refer to the maximum deflection defined by the stop.

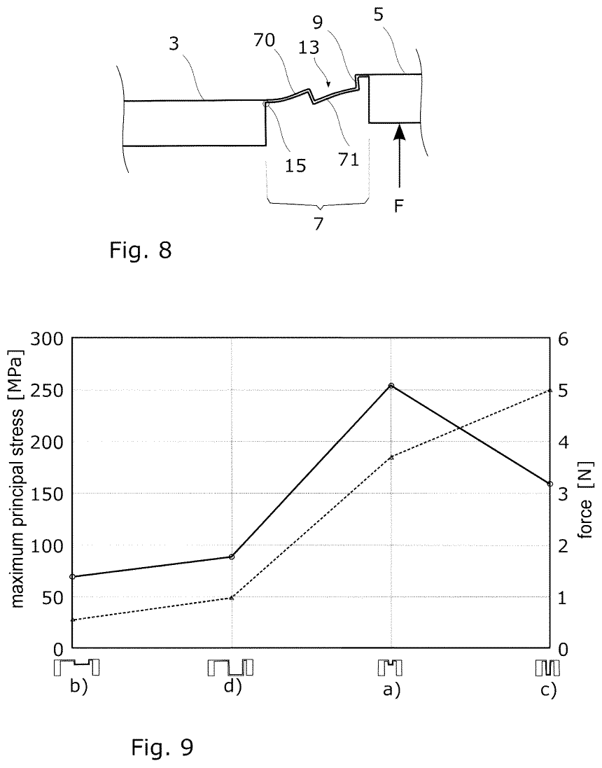

For clarification, FIG. 8 then shows the embodiments according to FIG. 6 b) under the action of a force F. The force F deflects the second portion 5 perpendicularly to the surface, e.g. to the sides 10, 11. The region of maximum tensile stress 15, which occurs at the inner edge, at the transition from the connecting portion 7 to the first portion 3, is indicated in FIG. 8.

FIG. 9 shows a diagram indicating the stresses and forces that occur with a given deflection for the same embodiments of glass elements 1 that are also taken as a basis for the diagram in FIG. 7. The values, which are obtained by simulation calculation, refer to a deflection of 0.03 mm. The values connected by the solid line denote the maximum stresses that occur with the deflection of 0.03 mm. The values connected by the dashed line are the respective forces required for said deflection.

The required force (curve in dashed lines) for the same deflection is 10 times less for the embodiment shown in FIG. 6 b) (on the left in the diagram) than for the embodiment shown in FIG. 6 c). In contrast, the stresses vary by a factor of only about 4 with a maximum value in the case of the “narrow and short” variant in FIG. 6 a).

All the embodiments shown here have advantages and disadvantages, depending on the application. Thus, stiffer or else more flexible connections may be desired. In the case of some applications, however, large deflections with as low as possible stresses are of particular advantage. These properties are achieved especially with wide horizontal webs or wide strips 70, 71. In contrast, long vertical webs, that is to say long offset webs 9, tend to result in stiffer connecting elements. In order to obtain a connecting portion 7 which is relatively easy to deform, it is therefore advantageous if the sum of the widths of the at least two strips 70, 71 situated at different levels is greater than the width of the offset web 9 connecting the two strips 70, 71. In this case, the width of the offset web 9, like the width of the strips 70, 71, is in each case measured along the surface thereof. To allow precise determination of the widths of the strips 70, 71 and of the offset web 9, the widths on the opposite sides can be averaged. In the case of the strip 70 in the example shown in FIG. 5, the averaged width dimension thus ends at the center line of the offset strip 9. The averaged width dimension B has been entered on FIG. 5 for the sake of illustration. The sum of the widths of two strips 70, 71 is preferably at least greater by a factor of 3 than the width of the offset web 9. This is the case, for instance, in the example in FIG. 6 b).

Irrespective of the specific shaping, provision is made, in a development of the glass element, for the portion 7 to be structured in such a way that the stresses in material of the element, i.e. in the glass, caused by a movement of the second portion 5 relative to the first portion 3 are reduced by at least 50%, preferably at least 90%, particularly preferably at least 99%, in comparison with the movement, such as bending, of an unstructured portion, in particular of an unstructured portion without thickness reduction.

In general, the relative deflectability of the two portions 3, 5 is also dependent on the width of the connecting portion 7. In general, the connecting portion 7 is all the more easily deformable, the wider said portion is made. For this purpose, it is advantageous if the connecting portion 7 has a width which is at least 10% of the thickness of the glass element 7. In the case where the thickness of the glass in the regions 3, 5 differs, the abovementioned condition with respect to the greater of the thicknesses applies. A width of the connecting portion 7 which is at least 20% of the thickness of the glass element 1 is more preferred. A particular preference is a width of the connecting portion 7 of at least 50% of the glass thickness. In the case of a width which is too great, however, the stability of the glass element 1 may also be reduced. It is therefore furthermore generally preferred if the width of the connecting portion is at most 150% of the thickness of the glass element 1.

A glass element 1 of the kind described here can be produced by a method in which, first of all, a preform of a glass element 1 is prepared, and subsequently material is selectively removed from the preform, the removal of the material thus producing a connecting portion 7 which connects adjacent portions, namely a first portion 3 and a second portion 5 and which is bendable, and stretchable or compressible, thus enabling the first and the second portion 3, 5 to be moved relative to one another. In order to remove the material, several methods can be used and possibly also combined. These methods can include structuring laser ablation, selective laser etching, ablation with etching, etching with masking, especially a lithographic method, sandblasting and ultrasonic vibration lapping. Another method which can be used for the structuring described here is described in DE 10 2018 110 211.9, the content of which relating to the production of recesses in glass is also fully incorporated into the subject matter of the present disclosure. The method described therein is based on introducing a cavity into a substrate made of hard and brittle material, preferably glass, by directing the laser beam of an ultrashort pulse laser at one of the side faces of the substrate, that is to say in this case at the preform of the glass element 1 to be produced, and concentrating it by means of focusing optics to give an extended focus in the substrate. The energy introduced by the laser beam produces a filament-shaped area of damage in the volume of the substrate, extending to a predetermined depth in the volume and not passing through the substrate. After the introduction of at least two filament-shaped areas of damage, the substrate is exposed to an etching medium, which removes material from the substrate and widens the at least two filament-shaped areas of damage into filaments, wherein at least two filaments are connected to form a cavity. Such a cavity can then form a channel 13 in the connecting portion 7.

In general, therefore, the removal of the material can be performed by etching, in particular also after the preceding production of filament-shaped areas of damage, or alternatively, as described above, by ablation, or by abrasive removal.

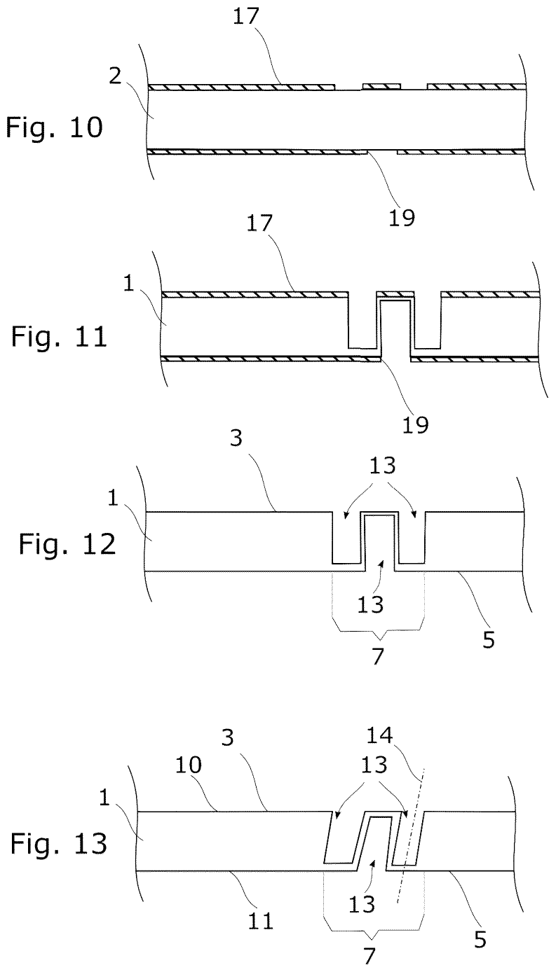

For the purpose of clarification, FIG. 10 to FIG. 12 show method steps for the production of a glass element 1 according to another embodiment. The method is based on selective removal of material brought about by means of masking. First of all, a mask 17 in the form of a structured coating is applied to a glass element preform 2 of the kind shown in FIG. 10. This can also be achieved by applying the layer in an unstructured form and then structuring it, e.g. lithographically. The mask 17 is structured in such a way that it has openings 19. As illustrated in FIG. 11, glass is then removed in the region of the openings 19, thus locally reducing the glass thickness and producing recesses. Finally, the mask 17 can be removed, and, as illustrated in FIG. 12, a glass element 1 is obtained in which the recesses form channels 13 in a flexible connecting portion 7, said channels being open toward opposite sides. The glass can be removed abrasively, e.g. by a jet of sand, or alternatively by etching.

After structuring and the resulting production of the connecting portion 7, the glass element 1 may also be processed further. Among the options considered here is processing of the surface of the glass element 1 on one or both sides. Such processing may include coating on one or both sides. However, prestressing is also an option to which particular consideration is given. Chemical prestressing is particularly preferred in this context. According to a further development, the glass element 1 is accordingly chemically prestressed. In this context, it is furthermore expedient for the prestressing to be carried out after the structuring, i.e. after the production of the connecting portion 7. In this case, the glass element, including the connecting portion 7, is accordingly prestressed, in particular chemically prestressed. The prestressing results in a compressive stress zone on both sides of the glass element, including the opposite surfaces of the connecting portion 7. The compressive stress is caused by an exchange layer produced by the prestressing. In the exchange layer, ions of the glass are at least partially replaced by larger ions. The replacement of sodium ions by potassium ions is a widespread practice. In this case, the exchange layer on both sides has a higher potassium concentration than the glass within the glass element.

FIG. 13 shows a variant of the glass element 1 with at least one offset strip 9 extending obliquely to the surface of the glass element 1, i.e. obliquely to at least one of the sides 10, 11. As a preferred option, a plurality of offset strips 9 is arranged obliquely, as also in the example illustrated. In other words, the angle of the surfaces of at least one of the offset strips 9 deviates from an angle of 90° with respect to the sides 10, 11. By virtue of this arrangement, the channels 13 are also arranged obliquely when viewed in cross section. The center plane 14 of the channels 13 is accordingly likewise oblique with respect to the sides 10, 11. By means of such an arrangement, it is possible to ensure that the force required for a deflection becomes dependent on the direction of the deflection, that is to say that, for example, the force for a deflection in a direction from side 10 toward side 11 differs from that for a deflection in the opposite direction. Without limitation to specific embodiments, provision is generally therefore made, according to yet another further development, for the connecting portion 7 to be shaped in such a way that the forces for deflections of the portions 3, 5 relative to one another differ when these deflections take place in opposite directions. Such an asymmetry in the deflection forces may also be achieved by means of shapes other than those of the obliquely extending channels 13 described above.

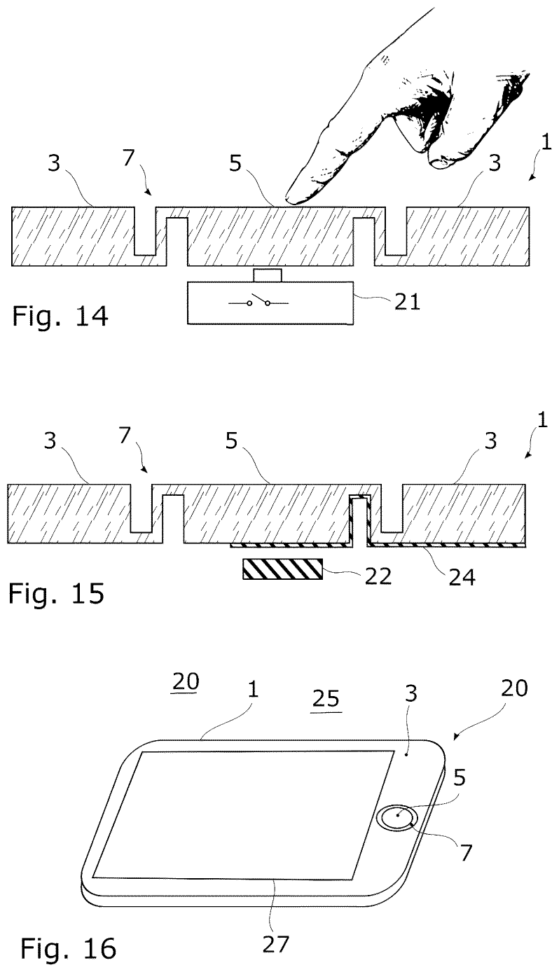

There are many applications for a glass element 1 of the kind described herein. In this regard, FIG. 14 shows an operating element, more specifically a manually operable pushbutton 21. The operating surface of the pushbutton 21 is formed by a glass element 1 according to this disclosure. For example, the glass element 1 can be used to actuate an electrical switch covered by said element. In the example in FIG. 14, the second portion 5 forms an operating element by means of which a pushbutton 21 located beneath it can be actuated.

FIG. 15 illustrates a variant in which the glass element 1 itself is part of an electrical switch. For this purpose, a switching contact 24, e.g. in the form of a conductive coating, is arranged on the glass element 1. By pressing on the second portion 5, said portion can be moved in the direction of another switching contact 22, with the result that the two switching contacts 22, 24 touch and establish an electrical contact or close a circuit. Without limitation to the examples illustrated, provision is thus made, according to one embodiment, for the glass element 1 or, more specifically, the second portion 5 to be used as part of an electrical switch.

The capacity of the second portion 5 for deflection with respect to the first portion 3 can be used inter alia to give haptic feedback to the operator. One possible use in this context is the screen cover of a display, e.g. a display of a smartphone or tablet PC. The screen cover can thus be provided with an integrated operating switch by means of the movable second portion 5. One such example is shown by the mobile electronic device 20 illustrated in FIG. 16. As stated, the mobile electronic device 20 can be a smartphone or a tablet PC and has a display 27, which is protected by a transparent screen cover 20. The screen cover 20 is formed by a glass element 1 according to this disclosure. In this case, the display 27 is covered by the first portion 3 of the glass element 1. The second portion 5 is a button of the kind illustrated, for example, in FIG. 14 or FIG. 15. This operating element can serve as a “Home button” for instance.

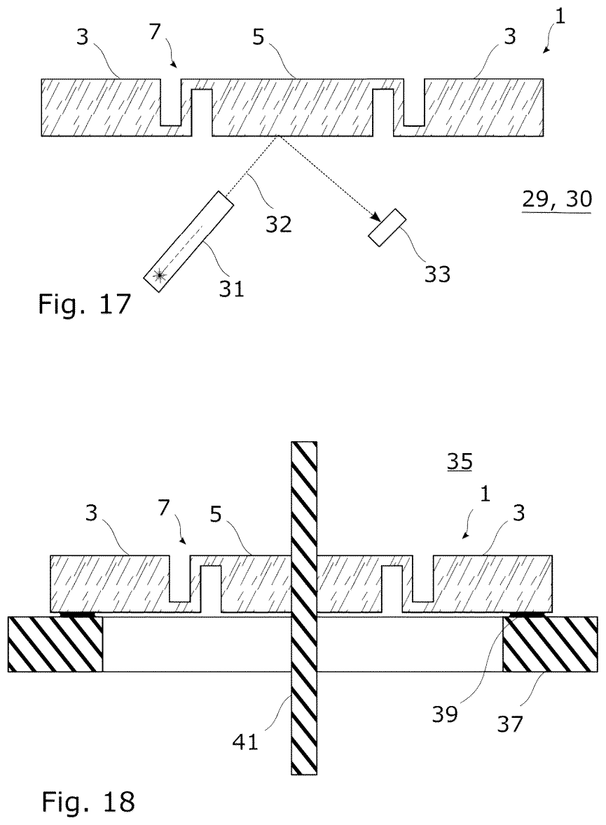

Another application is shown in FIG. 17. The glass element 1 can be used as a component part of a sensor 29. In this case, it is possible, in particular, for the sensor 29 to be designed to detect the deflection of the second portion 5, in order for example to measure forces or pressures. For pressure measurement, it is particularly advantageous that the connecting portion 7 is flexible and, at the same time, can be of fluidtight design. One possibility, which is also implemented in the example shown in FIG. 17, is optical detection of the deflection of the second portion 5. In the example, a laser diode 31 is provided, the laser beam 32 of which is directed at the second portion 5. The laser beam 5 reflected from the surface of the glass element 1 or second portion 5 is detected by a detector 33. Here, a deflection of the second portion 5 results in a change in the position of the point of impact of the laser beam 32 on the detector. Another possibility is capacitive detection, for example. In this case, the second portion can be provided with an electrode, e.g. with an electrically conductive coating. A change in the position of the second portion 5 can then be detected from the change in the distance with respect to a second electrode and the associated change in capacitance.

Conversely, the glass element 1 may also be a component part of an actuator 30. In the example illustrated, the second portion 5 could be moved actively for this purpose in order to deflect a laser beam 32.

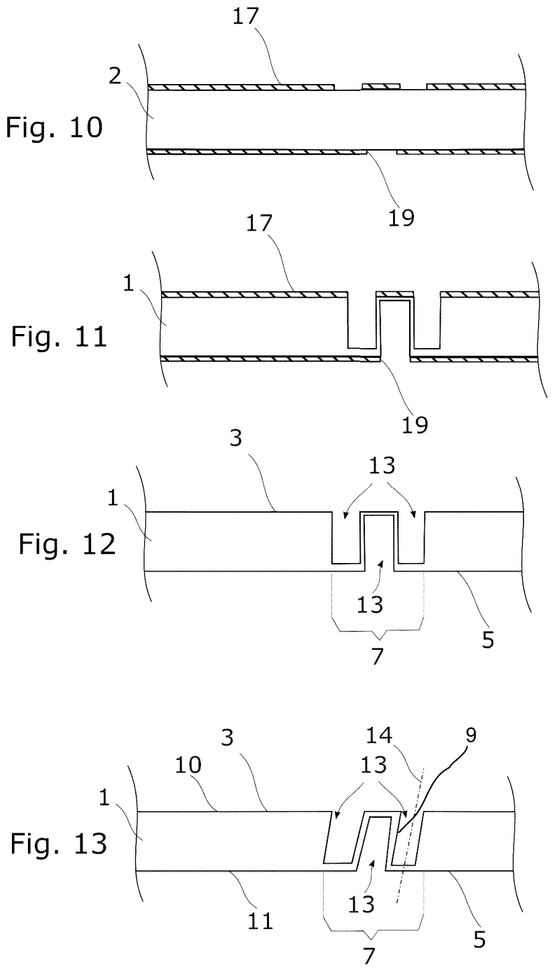

Another particularly advantageous application is use of the glass element 1 as insulation for an electrical leadthrough. An electrical leadthrough 35 of this kind is shown by the example in FIG. 18. In general, without restriction to the example shown, an electrical leadthrough 35 with a glass element 1 according to this disclosure is provided, in which a leadthrough conductor 41 is passed through the second portion 5 of the glass element 1 and is connected in a sealing manner to the glass of the glass element 1, and wherein the glass element 1 is connected in the first portion 3 to a flange, or a surround 37, such that the leadthrough conductor 41 is held at a distance from the surround, and the glass element 1 provides electrical insulation for the leadthrough conductor 41 with respect to the surround, and wherein the connecting portion 7 extends between the surround 37 and the leadthrough conductor 41 and annularly around the leadthrough conductor 41.

This arrangement ensures that the leadthrough conductor 41 is movable with respect to the surround. The special design of the connecting region 7, which is stretchable and compressible and, as a result, also tiltable, makes it possible to absorb both lateral shocks and those acting axially on the leadthrough conductor without damage to the leadthrough 35.

According to one embodiment, which is also implemented in the example in FIG. 18, the glass element 1 is connected to the surround 37 by means of a glass solder 39. The leadthrough conductor 41 can likewise also be secured in a matching opening in the second portion 5 of the glass element 1 by means of glass solder. This embodiment makes it possible to produce the glass element 1 in advance with the structuring of the connecting portion 7 and then to complete the leadthrough 35 by fitting the leadthrough conductor 41 and the surround 37 and preferably connecting these components hermetically by means of glass solder 39.

According to another embodiment, the leadthrough may also be produced first by embedding the leadthrough conductor 41 in the surround 37 with glass and then subsequently structuring said glass by removing glass to produce the connecting portion 7. During the embedding process, the leadthrough conductor 41 and the surround 37 are held in a mold, and the gap is filled with glass material. The arrangement is then heated up until the glass material melts and a glass element, or a glass preform, is formed.

It would be understood to a person skilled in the art that the various embodiments that are described herein may also be modified and combined in various ways. Thus, inter alia, the disclosure is not limited to glass elements with a single second portion 5. On the contrary, a glass element 1 may have a plurality of such second portions 5 capable of moving relative to the first portion 3 with the aid of a connecting portion 7. These may also be shaped differently, depending on the application.

List of reference signs

| | |
|---|---|
| 1 | Glass element |
| 2 | Glass element preform |
| 3 | First portion |
| 5 | Second portion |
| 7 | Connecting portion |
| 8 | Surface offset |
| 9 | Offset web |
| 10, 11 | Sides of 1 |
| 13 | Channel |
| 14 | Center plane of 13 |
| 15 | Region of maximum tensile stress |
| 17 | Masking |
| 19 | Opening in 17 |
| 20 | Screen cover |
| 21 | Pushbutton |
| 22, 24 | Switching contacts |
| 23 | Electrical switch |
| 25 | Portable electronic device |
| 27 | Display region |
| 29 | Sensor |
| 30 | Actuator |
| 31 | Laser diode |
| 32 | Laser beam |
| 35 | Electrical leadthrough |
| 37 | Surround, flange |
| 39 | Glass solder |
| 41 | Leadthrough conductor |
| 70, 71 | Strip of 7 |
| B | Averaged width dimension |

1-15. (canceled)

16: A glass element comprising:
a first portion;
a second portion deflectable with respect to the first portion; and
a connecting portion connecting the first portion and the second portion,
the first portion, the second portion and the connecting portion being formed in one piece, the connecting portion being designed to be flexibly deformable in such a way that the connecting portion is bendable, and stretchable or compressible, thus enabling the second portion to be moved with respect to the first portion, with the connecting portion being deformed,
the connecting portion being at least one loop or meander.

17: The glass element as recited in claim 16 wherein the connecting portion enables a movement of the second portion with respect to the first portion in a direction having a component perpendicular to the surface of the second portion.

18: The glass element as recited in claim 17 wherein the connecting portion has a reduced thickness relative to the first or the second portion, at least in some region or regions.

19: The glass element as recited in claim 18 wherein the reduced thickness relative to the first or the second portion has a value in the range of 10 μm to 200 μm, preferably in the range of 20 μm to 100 μm.

20: The glass element as recited in claim 16 wherein the glass element is of plate-shaped design, and the first portion surrounds the second portion.

21: The glass element as recited in claim 16 wherein the connecting portion has a form of a closed or encircling ring.

22: The glass element as recited in claim 16 wherein the connecting portion surrounds the second portion in a ring shape.

23: The glass element as recited in claim 16 wherein the glass element has at least one of the following features:
the connecting portion has at least one surface offset, such that the connecting portion has at least two strips, surfaces of the strips at different levels in a direction perpendicular to the surface of the first or the second portion;
the surface of the connecting portion is shaped in such a way that at least one channel is formed;
the connecting portion is structured in such a way that the stresses in the glass caused by a movement of the second portion relative to the first portion are reduced by at least 50% of an unstructured portion;
the glass element, including the connecting portion, is chemically prestressed; and
the connecting portion is designed in such a way that a maximum stress which is less than 400 MPa occurs in the connecting portion in the case of loading.

24: The glass element as recited in claim 16 wherein the connecting portion is structured in such a way that the stresses in the glass caused by a movement of the second portion relative to the first portion are reduced by at least 90%.

25: The glass element as recited in claim 16 wherein the connecting portion is designed in such a way that a maximum stress less than 200 MPa occurs in the connecting portion in the case of loading.

26: The glass element as recited in claim 16 wherein the connecting portion has a plurality of channels such that adjacent channels are open toward different sides of the glass element.

27: The glass element as recited in claim 16 wherein the connecting portion has at least one surface offset, such that the connecting portion has at least two strips, surfaces of the strips at different levels in a direction perpendicular to the surface of the first or the second portion, a sum of the widths of the at least two strips situated at different levels being greater than a width of an offset web connecting the two strips.

28: The glass element as recited in claim 16 wherein the connecting portion has at least one surface offset, such that the connecting portion has at least two strips, of the two strips extending obliquely to at least one of the sides of the glass element.

29: The glass element as recited in claim 16 wherein the connecting portion forms a gastight connection between the first portion and the second portion.

30: The glass element as recited in claim 16 wherein the connecting portion has a width which is at least 10% of the thickness of the glass element.

31: The glass element as recited in claim 16 wherein the connecting portion has a width which is at least 20% of the thickness of the glass element.

32: A method for producing the glass element as recited in claim 16, the method comprising:
preparing a preform of a glass element; and
selectively removing material from the preform, the removal of the material thus producing the connecting portion.

33: The method as recited in claim 32 wherein the removal of the material is performed by at least one of the following methods: etching, ablation, and abrasive removal.

34: An electrical leadthrough comprising:
the glass element as recited in claim 16;
a leadthrough conductor passed through the second portion of the glass element and connected in a sealing manner to the glass of the glass element;
the glass element being connected in the first portion to a surround, such that the leadthrough conductor is held at a distance from the surround,
the glass element providing electrical insulation for the leadthrough conductor with respect to the surround, and
the connecting portion extending between the surround and the leadthrough conductor and annularly around the leadthrough conductor.

35: A method for employing the glass element as recited in claim 16 comprising employing the glass element as one of the following:
as part of an electrical switch;
a screen cover of a display;
a component part of a sensor;
a component part of an actuator, and
insulation for an electrical leadthrough.
